(19) United States
(12) Patent Application Publication
(10) Pub. No.: US 2007/0226374 A1
(43) Pub. Date: Sep. 27, 2007

(54) System and method for identifying favorite service providers

(76) Inventors: Scott L. Quarterman, Norcross, GA (US); Mathew L. Grell, Norcross, GA (US)

Correspondence Address: Mathew L. Grell, Esq., 4307 Jones Bridge Circle, Norcross, GA, 30092, US

(21) Appl. No.: 11/388,104

(22) Filed: Mar. 23, 2006

(51) Int. Cl. G06F 15/16

(52) U.S. Cl. 709/250

(57) ABSTRACT

A system and method for identifying favorite or local favorite service provider(s) comprising searching, sorting, and/or filtering of service providers based on average user rating, review and/or recommendation of such service or the number of users who add service provider to their list of “My Favorites” or the number of members of a group who add service provider to their list of “My Favorites.”

### RELATED US APPLICATION

This application is related to the following concurrently filed patent application U.S. Non-Provisional patent application entitled “SYSTEM AND METHOD FOR FILTERING SEARCH QUERY RESULTS,” filed on Oct. 5, 2005, having assigned Ser. No. 11/243,837.

### COPYRIGHT NOTICE

A portion of the disclosure of this patent document contains material which is subject to copyright protection. The copyright owner has no objection to the facsimile reproduction by anyone of the patent document or patent disclosure as it appears in the U.S. Patent and Trademark Office patent file or records, but otherwise reserves all copyright rights whatsoever.

### TECHNICAL FIELD

The present invention relates generally to Internet and/or telecommunications systems and more specifically to a method, system and apparatus for identifying favorite service provider(s).

### BACKGROUND

Local service providers primarily focus the majority their advertising dollars on yellow page listings as their primary form of advertising, both in print and online, to distribute contact, goods and/or services information to customers seeking said goods and/or services. Examples of these are the regional Bell operating companies' yellow pages and websites, such as www.realpages.com www.yellowpages.com www.superpages.com and http://yp.yahoo.com. In use, a user of the yellow pages searches for a service provider by searching through an index of service providers within the yellow page book or online at one of the above listed websites. The user selects a provider and telephones the service provider by dialing the phone number listed in such directory or emails the service provider or visits service provider's website, and inquires about the service provider's goods and/or services. However, these sites do not focus on helping the user or consumer make an informed decision when selecting a service provider, but rather their focus is distributing the service provider's contact information and description of their goods and/or services.

Currently, consumers have limited means available for quickly finding reputable and qualified service providers in their local area such as dry-cleaning, car repair, dentists, home improvement contractors, auto mechanics, and the like. Most users or consumers rely on the above yellow pages and or word-of-mouth referrals from their friends, family, or coworkers to find local service providers. The problem with this is that the referral is based on a very limited sample of service providers and/or the referral is likely based on a single evaluation of the service provider's performance.

Websites exist where consumers can rate and review local businesses (service providers), and where consumers have access to the contact information of such service providers. This information assists consumers when making a decision to engage the services or purchase the goods of such a provider. In addition, websites exists that allow a user to rate and review service providers, but these websites fail to allow a user or member to sort service providers based on ratings, reviews, and/or recommendations by users, members, friends, friends of friends, and/or groups, such as individuals or groups of individuals the user trusts, shares similar interests, needs, associations and/or other factors, or identify and/or label such service providers as a favorite or local favorite service provider.

Therefore, for the foregoing reasons, it is readily apparent that there is a need for a method, system and apparatus for identifying favorite or local favorite service provider(s).

### BRIEF DESCRIPTION

Briefly described, in a preferred embodiment, the present invention overcomes the above-mentioned disadvantage, and meets the recognized need for such an invention by providing apparatus, system, process and method for identifying, labeling, searching, viewing, sorting and/or filtering favorite or local favorite service provider(s), wherein the present invention provides for the searching, sorting, labeling, and/or filtering of service providers based on average user rating, review and/or recommendation of such service provider; the number of positive reviews (“excellent” or “very Good”) for such service provider; the number of users or members who confirm (click) that a positive review for such service provider was useful verses the number of users or members who confirm that a positive review was not useful; the number of users who add service provider to their list of “My Favorites”; the number of groups who add service provider to their list of “My Favorites” or combinations thereof.

According to its major aspects and broadly stated, the present invention in its preferred form is a method, system and apparatus for identifying favorite or local favorite service provider(s), comprising, in general, a process to access a database of service provider(s), a process for identifying and/or labeling the best or above average service provider(s), a process to search for such service provider(s), a process to view such service provider(s), and/or a process for selectively sorting or filtering such service provider(s).

More specifically, the present invention is a communication system that shares information, such as contact information, ratings, reviews, recommendations and other information relating to service providers, with members or users and allows such members or users to selectively sort and/or filter such information based on feedback of highly rated, reviewed or recommended (favorite) service provider(s).

Accordingly, a feature and advantage of the present invention is its ability to provide a member or user with the ability to search, view, sort and/or filter a list of service providers and their contact information, feedback, ratings, reviews, recommendations and/or other service provider information based on qualifying as a best service providers(s).

Another feature and advantage of the present invention is its ability to provide a member or user with the ability to search, view, sort and/or filter a list of service providers and their contact information, ratings, reviews, recommendations and/or other service provider feedback or information based on qualifying as an above average service provider(s).

Still another feature and advantage of the present invention is its ability to provide a member or user with the ability to search, view, sort and/or filter a list of service providers and their contact information, ratings, reviews, recommendations and/or other service provider feedback or information based on service provider(s) meeting a quality of service threshold.

Yet another feature and advantage of the present invention is its ability to provide a member or user with the ability to search, view, sort and/or filter a list of service providers and their contact information, ratings, reviews, recommendations and/or other service provider feedback or information based on the average member(s) or user(s) rating of such service provider(s).

Yet another feature and advantage of the present invention is its ability to provide a member or user with the ability to search, view, sort and/or filter a list of service providers and their contact information, ratings, reviews, recommendations and/or other service provider feedback or information based on the average member(s) or user(s) review of such service provider(s).

Yet another feature and advantage of the present invention is its ability to provide a member or user with the ability to sort and/or filter a list of service providers and their contact information, ratings, reviews, recommendations and/or other service provider feedback or information based on the average member(s) or user(s) recommendation of such service provider(s).

Yet another feature and advantage of the present invention is its ability to provide a member or user with the ability to search, view, sort and/or filter a list of service providers and their contact information, ratings, reviews, recommendations and/or other service provider feedback or information based on whether the positive reviews “clicked useful” exceeds the number of positive reviews “clicked not useful”.

Yet another feature and advantage of the present invention is its ability to provide a member or user with the ability to search, view, sort and/or filter a list of service providers and their contact information, ratings, reviews, recommendations and/or other service provider feedback or information based on number of times service provider is added to a member or user's “My Favorites List”.

Yet another feature and advantage of the present invention is its ability to provide a member or user with the ability to search, view, sort and/or filter a list of service providers and their contact information, ratings, reviews, recommendations and/or other service provider feedback or information based on number of times service provider is added to a group of member or user's “My Favorites List”.

Yet another feature and advantage of the present invention is its ability to provide a member or user with the ability to search, view, sort and/or filter a list of service providers and their contact information, ratings, reviews, recommendations and/or other service provider feedback or information based on service providers or highly rated service providers offering a coupon.

Yet another feature and advantage of the present invention is its ability to provide a member or user with the ability to search, view, sort and/or filter a list of service providers and their contact information, ratings, reviews, recommendations and/or other service provider feedback or information based on highly rated service providers in member or user's area.

These and other features and advantages of the present invention will become more apparent to one skilled in the art from the following description and claims when read in light of the accompanying drawings.

### BRIEF DESCRIPTION OF THE DRAWINGS

The present invention will be better understood by reading the Detailed Description of the Preferred and Alternate Embodiments with reference to the accompanying drawing figures, in which like reference numerals denote similar structure and refer to like elements throughout, and in which:

FIG. 1 is a block diagram of a computer system.

FIG. 2 is a block diagram of a communications system implemented by the system in FIG. 1.

FIG. 3 is a flow diagram of a communication method, according to the preferred embodiment of the present invention, implemented by the system in FIG. 2.

FIG. 4 is a screen shot of a user interface of the method of FIG. 3 according to the preferred embodiment of the present invention.

FIG. 5 is a screen shot of a user interface of the method of FIG. 3 according to the preferred embodiment of the present invention.

FIG. 6 is a screen shot of a user interface of the method of FIG. 3 according to the preferred embodiment of the present invention.

FIG. 7 is a screen shot of a user interface of the method of FIG. 3 according to the preferred embodiment of the present invention.

FIG. 8 is a screen shot of a user interface of the method of FIG. 3 according to the preferred embodiment of the present invention.

FIG. 9 is a screen shot of a user interface of the method of FIG. 3 according to the preferred embodiment of the present invention.

FIG. 10 is a screen shot of a user interface of the method of FIG. 3 according to the preferred embodiment of the present invention.

### DETAILED DESCRIPTION OF THE PREFERRED AND ALTERNATIVE EMBODIMENTS

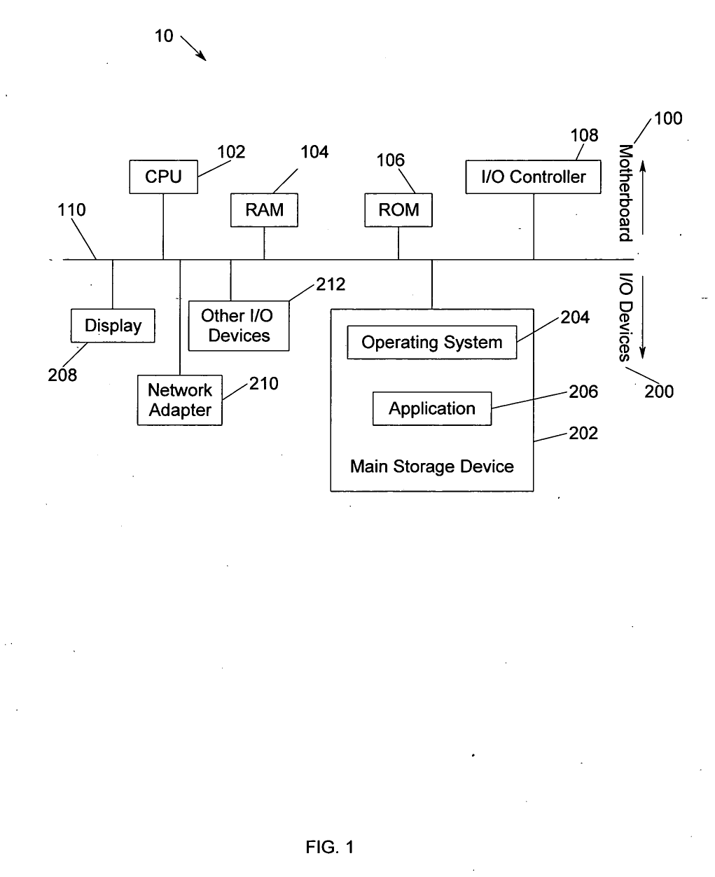

In describing the preferred and alternate embodiments of the present invention, as illustrated in FIGS. 1-10, specific terminology is employed for the sake of clarity. The present invention, however, is not intended to be limited to the specific terminology so selected, and it is to be understood that each specific element includes all technical equivalents that operate in a similar manner to accomplish similar functions.

As will be appreciated by one of skill in the art, the present invention may be embodied as a method, data processing system, or computer program product. Accordingly, the present invention may take the form of an entirely hardware embodiment, entirely software embodiment or an embodiment combining software and hardware aspects. Furthermore, the present invention may take the form of a computer program product on a computer-readable storage medium having computer-readable program code means embodied in the medium. Any suitable computer readable medium may be utilized including hard disks, ROM, RAM, CD-ROMs, electrical, optical or magnetic storage devices.

The present invention is described below with reference to flowchart illustrations of methods, apparatus (systems) and computer program products according to embodiments of the present invention. It will be understood that each block or step of the flowchart illustrations, and combinations of blocks or steps in the flowchart illustrations, can be implemented by computer program instructions. These computer program instructions may be loaded onto a general purpose computer, special purpose computer, or other programmable data processing apparatus to produce a machine, such that the instructions, which execute on the computer or other programmable data processing apparatus create means for implementing the functions specified in the flowchart block or blocks/step or steps.

These computer program instructions may also be stored in a computer-usable memory that can direct a computer or other programmable data processing apparatus to function in a particular manner, such that the instructions stored in the computer-usable memory produce an article of manufacture including instruction means which implement the function specified in the flowchart block or blocks/step or steps. The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions specified in the flowchart block or blocks/step or steps.

Accordingly, blocks or steps of the flowchart illustrations support combinations of means for performing the specified functions, combinations of steps for performing the specified functions and program instruction means for performing the specified functions. It will also be understood that each block or step of the flowchart illustrations, and combinations of blocks or steps in the flowchart illustrations, can be implemented by special purpose hardware-based computer systems, which perform the specified functions or steps, or combinations of special purpose hardware and computer instructions.

Computer program for implementing the present invention may be written in various programming languages, such as conventional C calling. However, it is understood that other source or object oriented programming languages, and other conventional programming language may be utilized without departing from the spirit and intent of the present invention.

Referring now to FIG. 1-10, the present invention in its preferred embodiment is an apparatus, system and method for identifying, labeling, searching, viewing, sorting and/or filtering favorite or local favorite service provider(s), wherein the present invention provides for the searching, sorting, and/or filtering of service providers feedback or information based on average user rating, review and/or recommendation of such service provider; the number of positive reviews (“excellent” or “very Good”) for such service provider; the number of user or member who confirm (click) that a positive review for such service provider was useful verses the number of user or member who confirm that a positive review was not useful; the number of users who add service provider to their list of “My Favorites”; the number of groups who add service provider to their list of “My Favorites” or combinations thereof. For brevity, several elements in the figures described below are represented as monolithic entities. However, as would be understood by one skilled in the art, these elements each may include numerous interconnected computers and/or components designed to perform a set of specified operations and/or dedicated to a particular geographical region.

Referring now to FIG. 1, there is illustrated a block diagram of a computer system 10 that provides a suitable environment for implementing embodiments of the present invention. The computer architecture shown in FIG. 1 is divided into two parts—motherboard 100 and the input/output (I/O) devices 200. Motherboard 100 includes subsystems such as central processing unit (CPU) 102, random access memory (RAM) 104, input/output (I/O) controller 108, and read-only memory (ROM) 106, also known as firmware, which are interconnected by bus 110. A basic input output system (BIOS) containing the basic routines that help to transfer information between elements within the subsystems of the computer is stored in ROM 106 or operably disposed in RAM 104. Computer system 10 further includes I/O devices 200 such as main storage device 202 for storing an operating system 204 and application program(s) 206 and display 208 for visual output, respectively. Main storage device 202 is connected to CPU 102 through a main storage controller (represented as 108) connected to bus 110. Network adapter 210 allows the computer system to send and receive data through communication devices. One example of a communications device is a modem including both cable and digital subscriber line (DSL). Other examples include a transceiver, a set-top box, a communication card, a satellite dish, an antenna, or any other network adapter capable of transmitting and receiving data over a communications link that is either a wired, optical, or wireless data pathway.

Many other devices or subsystems 212 may be connected in a similar manner, including but not limited to, devices such as microphone, speakers, sound card, keyboard, pointing device (e.g., a mouse), floppy disk, CD-ROM player, printer and/or modem each connected via I/O adapter. Also, it is not necessary for all of the devices shown in FIG. 1 to be present to practice the present invention, as discussed below. Furthermore, the devices and subsystems may be interconnected in different ways from that shown in FIG. 1 or be based on optical or biological processors or gate arrays or some combination of these elements that is capable of responding to and executing instructions. The operation of a computer system such as that shown in FIG. 1 is readily known in the art and is not discussed in further detail in this application, so as not to overcomplicate the present discussion.

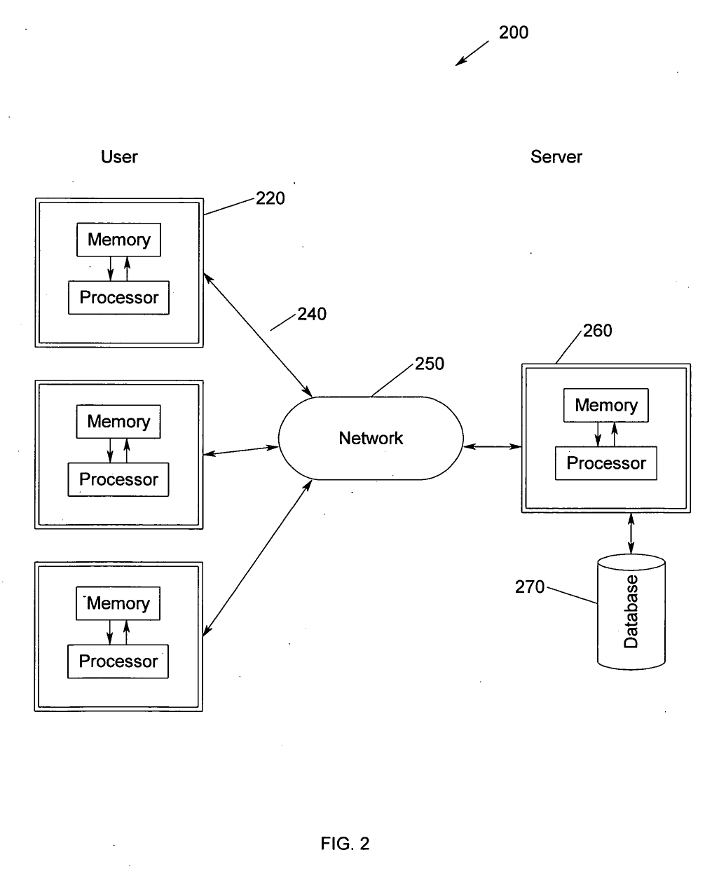

Referring now to FIG. 2, there is illustrated a diagram depicting an exemplary system in which concepts consistent with the present invention may be implemented. Examples of each element within the communication system of FIG. 2 are broadly described above with respect to FIG. 1. In particular, the server system 260 and user system 220 have attributes similar to computer system 10 of FIG. 1 and illustrates one possible implementation of that system. The communication system 200 includes one or more user system 220, and one or more server device 260, and a network 250, which could be, for example, the Internet. User systems 220 each include a computer-readable medium, such as random access memory, coupled to a processor. The processor executes program instructions stored in memory. User system 220 may also include a number of additional external or internal devices, such as, without limitation, a mouse, a CD-ROM, a keyboard, a display, a storage device and other attributes similar to computer system 10 of FIG. 1. The communications system 200 typically includes one or more user system 220. For example, the user system 220 may include one or more general-purpose computers (e.g., personal computers), one or more special purpose computers (e.g., devices specifically programmed to communicate with each other and/or the server system 260), a workstation, a server, a device, a digital assistant or a “smart” cellular telephone or pager, a component, other equipment, or some combination of these elements that is capable of responding to and executing instructions.

Similar to user system 220, server system 260 includes a computer-readable medium, such as random access memory, coupled to a processor. The processor executes program instructions stored in memory. Server system 260 may also include a number of additional external or internal devices, such as, without limitation, a mouse, a CD-ROM, a keyboard, a display, a storage device and other attributes similar to computer system 10 of FIG. 1. Server system 260 may additionally include a secondary storage element, such as database 270 for storage of data and information. Server system 260, although depicted as a single computer system, may be implemented as a network of computer processors. Memory in server system 260 contains one or more application program(s) 206 (shown in FIG. 1). For example, the server system 260 may include one or more general-purpose computers (e.g., personal computers), one or more special purpose computers (e.g., devices specifically programmed to communicate with each other) a workstation or other equipment, or some combination of these elements that is capable of responding to and executing instructions.

Communications system 200 is capable of delivering and exchanging data between user system 220 and a server system 260 through communication links 240 and/or network 250. Through user system 220, users can communicate over network 250 with each other and with other systems and devices coupled to network 250, such as server system 260. The communications link 240 typically includes a delivery network 250 making a direct or indirect communication between the user system 220 and the server system 260, irrespective of physical separation. Examples of a network 250 include the Internet, the World Wide Web, WANs, LANs, analog or digital wired and wireless telephone networks (e.g. PSTN, ISDN, or XDSL), radio, television, cable, satellite, and/or any other delivery mechanism for carrying and/or transmitting data or other information. The communications link 240 may include, for example, a wired, wireless, cable, optical or satellite communication system or pathway.

Application program 206 (shown in FIG. 1) preferably includes search engine 280 (not shown), which locates relevant information in response to search queries from user system 220. In particular, a user operating user system 220 sends search queries or information request to server system 260, which server system 260 and its application programs responds to by returning such information to the user at user system 220. Preferably, user system 220 queries server system 260 to locate information relating to a particular category and/or sub category of service providers or based on a key word search of service providers. In a preferred embodiment of the present invention search engine 280 searches a set of service provider data, records, feedback and/or information stored in database 270 and responds to the user's query by returning a list of relevant data, records, feedback and/or information to the user at user system 220 matching user's search query. The user may query, request or instruct server system 260 and/or user system 220 to re-order the service provider data, feedback and/or information matching user's query based on friends, friends of friends, groups, friends of group, area, zip code, zip+4, city, metro area, state, highly rated reviewers, highly rated, reviewed and/or recommended service providers, distance, proximity, coupon, service providers added to user's, friends, and/or groups “My Favorites List”, or combinations thereof or other such information as would meet the purpose described herein. Application program 280 locates service providers from a body of service provider records stored in database 270 by comparing the terms in the user's search query to the service providers records in database 270. In general, processes for indexing records and searching the indexed body of records to return a set of records containing the searched terms are well known in the art.

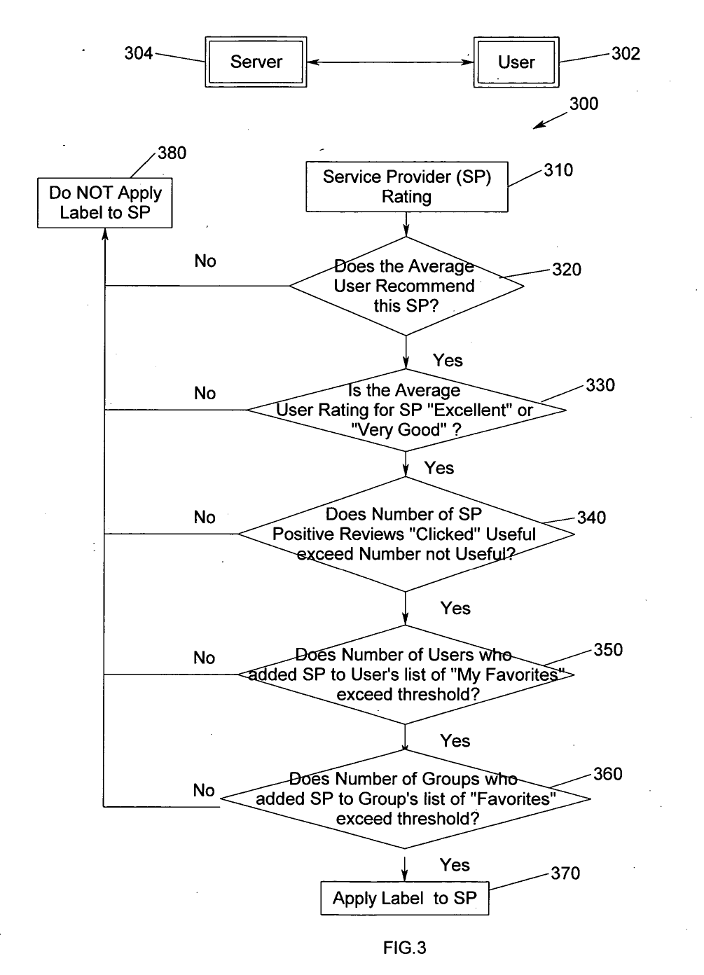

Referring now to FIG. 3, there is illustrated a preferred flow diagram in which user 302 and server 304 interact according to a process 300 within the communication system 200 of FIG. 2. User 302 preferably has attributes comparable to those described above with respect to user system 220. User 302 is referred to hereafter as a user of communication system 200 and/or member based on the system, methods and/or processes described herein. Server 304 preferably has attributes comparable to those described above with respect to server system 260. Server 304 is referred to hereafter as advertising source implemented by communication system 200 and based on the system, methods and/or processes described herein. Server 304 is preferably interconnected to user 302 through a known or described delivery network. The network preferably has attributes comparable to those described above with respect to network 250. Procedure 300 preferably can be implemented by communication system 200 or other similar hardware, software, device, computer, computer system, equipment, component, application, code, storage medium, or propagated signal.

As illustrated in FIG. 3, process 300 starts with step 310 wherein service provider(s) are identified or labeled as favorite or local favorite service provider(s) in process 300. In step 320, of process 300, server 304 preferably determines whether or not the average user 302 recommends service provider. (It is contemplated that thresholds other than average such as an individual user 302 or one or more user 302 may be a sufficient determination and/or whether such determination is made based on a pool of users 302 local to service provider or users 302 within service providers area, zip code, zip+4, city, metro area, or state.) Preferably, if the average user 302 recommends service provider by clicking a radial button labeled “yes” following a question “Would you recommend this company?” then service provider is labeled and/or identified as a “favorite” service provider. Otherwise, service provider is not labeled and/or identified as a “favorite” service provider. It is contemplated that step 320 of process 300 is performed for each service provider. It is further contemplated that other recommendation systems including, but not limited to, buttons, check boxes, questions and the like and/or other designations or labels other than “recommend” including, but not limited to, locally recommended, a designated area recommended (i.e., Recommended in Norcross), area, best, very good, excellent, quality, preferred, highly recommended, and/or whether for a category or subcategory, and the like are contemplated in the present invention.

Thereafter, process 300 proceeds to the next step 330 of process 300, wherein server 304 determines whether the average user 302 rating of service provider on a scale of 1 to 5. (It is contemplated that thresholds other than average such as an individual user 302 or one or more user 302 may be a sufficient determination and/or whether such determination is made based on a pool of users 302 local to service provider or users 302 within service providers area, zip code, zip+4, city, metro area, or state.) Preferably, if the average user 302 rating of service provider is a 4 (“Very Good”) or 5 (“Excellent”) rating out of a total of 5 then service provider is labeled and/or identified as a “favorite” service provider. Otherwise, service provider is not labeled and/or identified as a “favorite” service provider. It is contemplated that step 330 of process 300 is performed for each service provider. It is further contemplated that other rating, review, or recommendation scales including but not limited to 1 to 10 or icon counts and the like and/or other designations or labels other than “favorite” including, but not limited to, local favorite, a designated area favorite (i.e., Favorite in Norcross), area, best, very good, excellent, quality, preferred, highly rated, reviewed or recommended, and/or whether for a category or subcategory, and the like are contemplated in the present invention.

Thereafter, process 300 proceeds to the next step 340 of process 300, wherein server 304 preferably determines whether or not the number of service provide positive ratings (i.e., 3, 4, or 5 out of 5) designated as useful exceed the number of positive ratings designated as not “useful”. (It is contemplated that thresholds other than exceed such as an individual user 302, one or more user 302, or determining whether number of positive reviews designated as “useful” exceeds the number of negative ratings (i.e., 1, and 2 out of 5) designated as “useful” may be a sufficient determination and/or whether such determination is made based on a pool of users 302 local to service provider or users 302 within service providers area, zip code, zip+4, city, metro area, or state.) Preferably, user 302 designates service provider's review as “useful” by clicking a radial button labeled “yes” following a question “Was this review useful?” Thus, if the number of positive (yes) reviews designated as “useful” exceeds the number of positive reviews designated as not “useful” then service provider is labeled and/or identified as a “favorite” service provider. Otherwise, service provider is not labeled and/or identified as a “favorite” service provider. It is contemplated that step 340 of process 300 is performed for each service provider. It is further contemplated that other review abuse systems including, but not limited to, buttons, check boxes, questions and the like and/or other designations or labels other than “useful” including, but not limited to, helpful, beneficial, best, very good, excellent, quality, preferred, highly rated, reviewed or recommended, and the like are contemplated in the present invention. It is further contemplated that other rating scales including but not limited to 1 to 10 or icon counts and the like and/or other designations or labels other than “favorite” including, but not limited to, local favorite, a designated area favorite (i.e., Favorite in Norcross), area, best, very good, excellent, quality, preferred, highly rated, reviewed or recommended, and/or whether for a category or subcategory, and the like are contemplated in the present invention.

Thereafter, process 300 proceeds to the next step 350 of process 300, wherein server 304 preferably determines whether a threshold of users 302 have added service provider to user's 302 list of “My Favorites.” (It is contemplated that thresholds such as an individual user 302 or one or more user 302 may be a sufficient determination and/or whether such determination is made based on a pool of users 302 local to service provider or users 302 within service providers area, zip code, zip+4, city, metro area, or state.) Preferably, user 302 designates service provider as “My Favorite” by selecting a service provider under the tab “Find Businesses” and upon viewing such service provider's information page user 302 may select to add service provider to user's 302 list of “My Favorites”. Thus, preferably if two or more users 302 add service provider to their list of “My Favorites” then service provider is labeled and/or identified as a “favorite” service provider. Otherwise, service provider is not labeled and/or identified as a “favorite” or “local favorite” service provider. It is contemplated that step 350 of process 300 is performed for each service provider. It is further contemplated that other designations or labels other than “My Favorite” including, but not limited to, beneficial, local favorite, a designated area favorite (i.e., Favorite in Norcross), area, best, very good, excellent, quality, preferred, highly rated, reviewed or recommended, and/or whether for a category or subcategory, and the like are contemplated in the present invention.

Thereafter, process 300 proceeds to the next step 360 of process 300, wherein server 304 preferably determines whether a threshold of users 302 within a group of users have added service provider to user's 302 list of “My Favorites.” (It is contemplated that thresholds such as an individual user 302 or one or more user 302 may be a sufficient determination and/or whether such determination is made based on a pool of users 302 local to service provider or users 302 within service providers area, zip code, zip+4, city, metro area, or state.) Preferably, user 302 designates service provider as “My Favorite” by selecting a service provider under the tab “Find Businesses” and upon viewing such service provider's information page user 302 may select to add service provider to user's 302 list of “My Favorites”. Moreover, user 302 may create a group of users or join an existing group of users 302 such as “My Groups”. Server 304 preferably determines whether a threshold of users 302 within a group of users have added service provider to user's 302 list of “My Favorites.” (It is contemplated that thresholds such as an individual user 302 or one or more user 302 may be a sufficient determination and/or whether such determination is made based on a pool of users 302 local to service provider or users 302 within service providers area, zip code, zip+4, city, metro area, or state.) Thus, preferably if two or more users 302 within such group of users add service provider to their list of “My Favorites” or an average number of users 302 within such group of users 302 adds service provider to their list of “My Favorites” then service provider is labeled and/or identified as a “favorite” or “local favorite” service provider or “group favorite” or “local group favorite” service provider of the group. Otherwise, service provider is not labeled and/or identified as a “favorite” service provider. It is contemplated that step 360 of process 300 is performed for each service provider. It is further contemplated that other designations or labels other than “My Favorite” including, but not limited to, beneficial, local favorite, a designated area favorite (i.e., Favorite in Norcross), area, best, very good, excellent, quality, preferred, highly rated, reviewed, or recommended, and/or whether for a category or subcategory, and the like are contemplated in the present invention. It is still further contemplated that other thresholds may be determined within the group of users 302 such as an algorithm or a group administrator to determine whether a service provider has met such threshold for service provider to be labeled and/or identified as a “favorite” service provider.

It is still further contemplated in each of the steps of process 300 that when determining whether a service provider is labeled and/or identified as a “favorite” or “local favorite” service provider the users 302 included in such determination may solely be users 302 that are local to that service provider. Local preferably means local to service provider, however other designations include but are not limited to local to friends, friends of friends, groups, friends of group, user 302, area, zip code, zip+4, city, metro area, state, highly rated reviewers, highly rated, reviewed and/or recommended service providers, distance, proximity, coupon, service providers added to user's, friends, and/or groups “My Favorites List”, or combinations thereof local to service provider, respectively or other such information as would meet the purpose described herein.

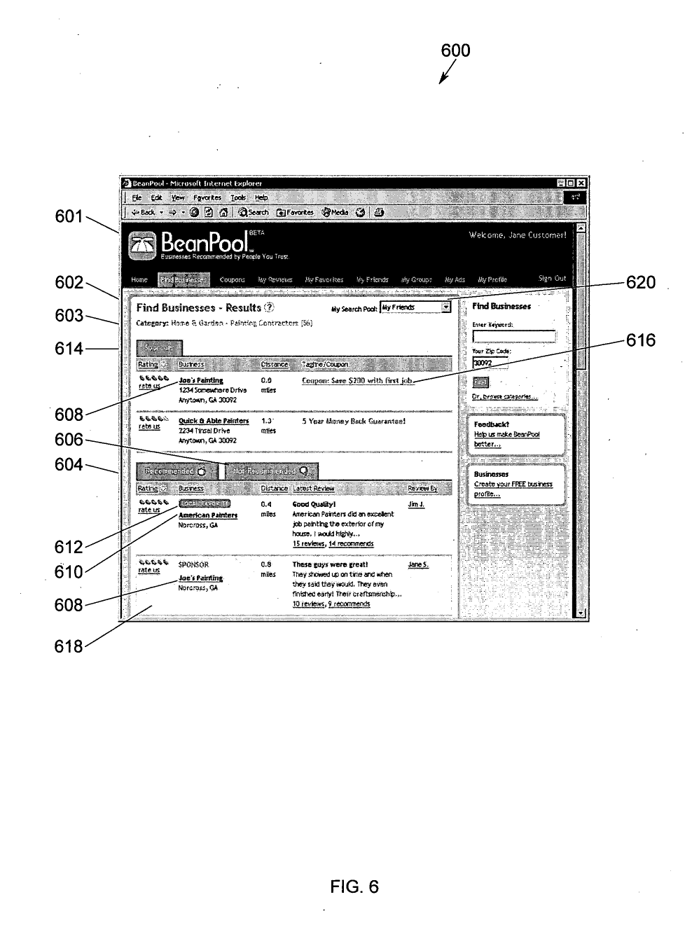

It is still further contemplated in each of the steps of process 300 when determining whether a service provider is labeled and/or identified as a “favorite” or “local favorite” service provider the users 302 included in such determination may vary depending on the user 302 query, request or instruction of server system 260 and/or user system 220 to re-order the service provider data and/or information matching user's query (My Search Pool in FIG. 6) based on friends, friends of friends, groups, friends of group, area, zip code, zip+4, city, metro area, state, highly rated reviewers, highly rated, reviewed and/or recommended service providers, distance, proximity, coupon, service providers added to user's, friends, and/or groups “My Favorites List”, or combinations thereof or other such information as would meet the purpose described herein. By user 302 changing the selection under My Search Pool (as shown in FIG. 6) server 304 produces a different list of service providers to be viewed by user 302. For example, user 302 may broaden or increase the list of services providers matching user 302 query by setting the My Search Pool (as shown in FIG. 6) to “City’ or user 302 may narrow or decrease the list of services providers matching user 302 query by setting the My Search Pool (as shown in FIG. 6) to ‘Friends.’

It is still further contemplated in each of the steps of process 300 when determining whether a service provider is labeled and/or identified as a “favorite” or “local favorite” the steps 320 through 360 of process 300 may be considered individually, or weighted individually or in combination to determining whether a service provider is labeled and/or identified as a “favorite” or “local favorite.”

It is still further contemplated in each of the steps of process 300 when determining whether a service provider is labeled and/or identified as a “favorite” or “local favorite” the steps 320 through 360 of process 300 may be based on an algorithm of individual steps or combinations of steps to determine whether a service provider is labeled and/or identified as a “favorite” or “local favorite.”

Service provider labeled and/or identified as a “favorite” or “local favorite” service provider may have any special designation, including but not limited to any mark, label, icon, text, script, font, or graphic whether static or dynamic, audio, and/or video.

It is still further contemplated in each of the steps of process 300 that information on service providers labeled and/or identified as a “favorite” or “local favorite” is communicated to user 302.

Service provider preferably is a business entity with a business line; however such entity may include but is not limited to, individual(s), sole proprietor, or other choice of entity such as, partnership, limited liability company, corporation, company or any other entity that advertises its goods and/or services.

Area preferably is advertiser or user's 302 immediate area where such user 302 or service provider conducts business or engages in commerce such as, including but not limited to, elementary, middle or high school district, area code, city, zip code, zip plus extension, GPS, radius from a central point, city, metro area, county, state, region, providence, country, union or combination thereof as would meet the purposes described herein.

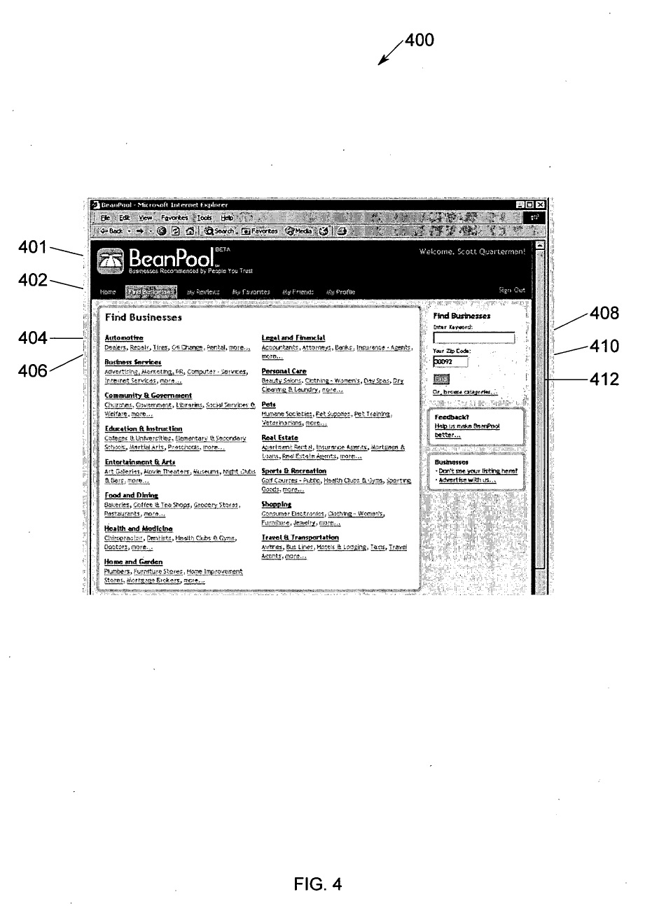

Referring now to FIGS. 4, 5, 6, 7 8, and 9, user 302 and service provider interact within the communication system 200 of FIG. 2. User 302 preferably has attributes comparable to those described above with respect to user system 220. Server 304 (advertising source and service provider listings) preferably has attributes comparable to those described above with respect to server system 260. User 302 is preferably interconnected to server 304 through a known or described delivery network. The network preferably has attributes comparable to those described above with respect to network 250. Advertising source in FIGS. 4 through 10 preferably has attributes comparable to those described above with respect to FIG. 3.

Referring now to FIG. 4, there is illustrated a preferred screen shot 400 of advertising source 401, wherein user 302 may select a service provider by clicking the tab button 402 designated as “Find Businesses.” Upon clicking the “Find Businesses” tab 402, advertising source 401 generates preferred screen shot 400 entitled “Find Businesses” listing categories 404 and subcategories 406 of service providers and alternatively provides a text entry box 408 that allows user 302 to enter a keyword(s) of a business name to locate service provider(s). In use, user 302 may mouse over and click any categories 404 and/or subcategories 406, or enter a text query into text entry box 408, enter user 302 zip code into text entry box 410 and click find 412. It is contemplated that multiple subcategories 406 exist and are represented for each category 404 and that for each category 404 or subcategory 406 advertising source 401 will generate a list of service providers matching the category 404 or subcategory 406 selected by user 302.

Categories (multiple category 404) may include, but are not limited to, automotive, business services, community & government, education and instruction, entertainment & arts, food & dinning, health & medicine, home & garden, legal & financial, personal care, pets, real estate, sports & recreation, shopping, and/or travel & entertainment as set forth in bold in FIG. 4.

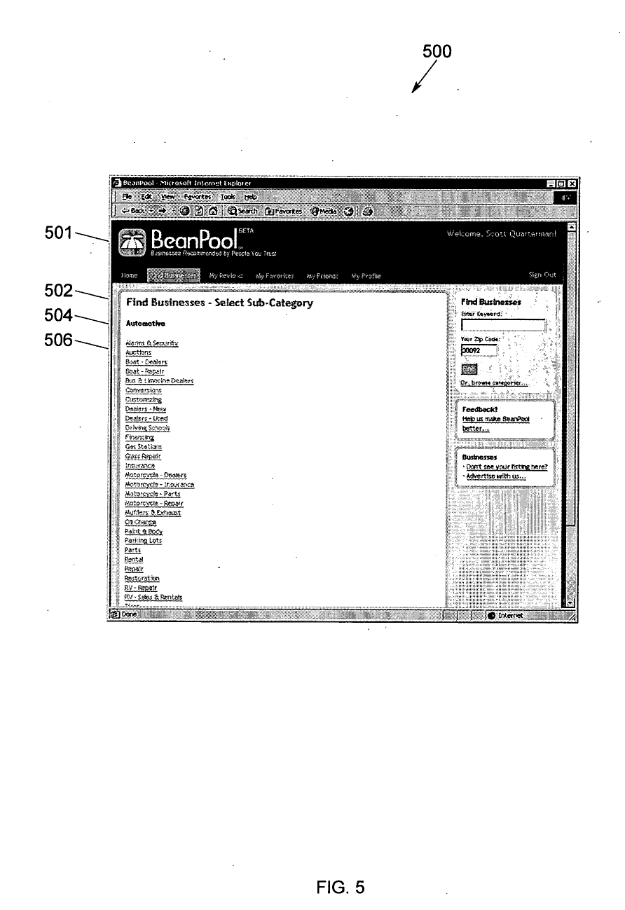

Referring now to FIG. 5, there is illustrated a preferred screen shot 500 of advertising source 501. By way of example, and not limitation, if user 302 clicks on a category, such as “Automotive” set forth above in FIG. 4, advertising source 501 generates preferred screen shot 500 entitled “Find Businesses—Select Sub-Category” 502 listing subcategories 506 such as “Alarms & Security”, “Auctions” and the like under “Automotive” category 504. User 302 may mouse over and click any subcategories 506.

By way of example, and not limitation, subcategories 506 under category “Automotive” may include Alarms & Security, Auctions, Boat-Dealers, Boat-Repair, Bus & Limosine Dealers, Conversions, Customizing, Dealers-New, Dealers-Used, Driving Schools, Financing, Gas Stations, Glass Repair, Insurance, Motorcycle-Dealers, Motorcycle-Insurance, Motorcycle-Parts, Motorcycle-Repair, Mufflers & Exhaust, Oil Change, Paint & Body, Parking Lots, Parts, Rental, Repair, Restoration, RV-Repair, RV-Sales & Rentals, Tires, Towing, Transmission Repair, Truck Dealers, Washing & Detailing, and the like as set forth in FIG. 5. It is contemplated that multiple subcategories 506 exist and are represented for each category 504 and that for each category 504 or subcategory 506 advertising source 501 will generate a list of service providers matching the category 504 or subcategory 506 selected by user 302.

Service providers are classified based Standard Industrial Classification (SIC), North American Industry Classification System (NASIC) and other code classification schemes. Such codes are preferably used to classify service providers into category 504 and subcategory 506.

Referring now to FIG. 6, there is illustrated a preferred screen shot 600 of advertising source 601, wherein user 302 may select from a list of service provider(s) matching user 302 query or selection. Upon user 302 clicking the categories 404 or subcategories 406 or clicking find 412 as set forth in FIG. 4, advertising source 601 generates preferred screen shot 600 entitled “Find Businesses—Results” 602 listing service providers 608 matching user 302 query or selection such as category/subcategory—“Home & Garden—Painting Contractors” 603 having for example 56 service providers. Preferred screen shot 600 includes tabs Recommended 604 and Not Recommended 606 each allowing user 302 to select and view a list of recommended service providers 608 (shown) or a list of not recommended service providers (not shown) matching user 302 query or selection. Preferred screen shot 600 includes drop down window 620 entitled “My Search Pool” populated with “My Friends” as the exemplary filter selection. Preferred screen shot 600 defaults to “City” as the drop down window 620 filter selection, wherein service providers are filtered to display service providers within user's 302 ‘City’ or selected city (service providers matching the filter selection ‘City’) or as a second example user 302 may select ‘My Friends’ as the drop down window 620 filter selection, wherein service providers are filtered to display service providers rated, reviewed and/or recommended by user's 302 friends listed under ‘My Friends’ (service providers matching the filter selection ‘My Friends’) and the like. Server 304 preferably filters the list of service providers matching user 302 drop down window 620 filter selection and displays such results for user 302. Moreover, user 302 may select a category and subcategory under Find Business results such as Home & Garden—Painting Contractors 603 having 56 service providers and thereafter user 302 preferably may select from drop down window 620 filter selection options and narrow/reduce the number of service providers preferably reducing service providers to service providers rated, reviewed and recommended by people user 302 trusts such as preferably selecting metro area to city, city to zip code, zip code to friends of friends, or friends of friends to friends, and the like, respectively. However, drop down window 620 filter may include but is not limited to friends, friends of friends, groups, friends groups, favorite service provider (such as ‘Local Favorite’ 612 labeled and/or identified as favorite or local favorite), favorite reviewer, favorite area, zip code, zip+4, city, metro area, state, highly rated, reviewed, or recommended reviewers, highly rated, reviewed, or recommended service providers, distance, proximity, coupon (service providers offering a coupon 616), or other designation as would meet the purposes described herein may be selected resulting in different lists of service providers matching user 302 filter selection. Drop down window 620 allows user 302 to select and apply a filter to the database list of service provider(s) generated by user's 302 key word query 408 or selection of category/subcategory of service providers 404, 406 or 608 or as set forth in FIGS. 4, 5, and/or 6. For example, when drop down window 620 is set to ‘City’ (preferably default setting) advertising source 601 preferably produces a list of service providers for the query or selection within the category/subcategory selected by user 302 having the same city as user 302 or other designated city selected by user 302. In addition as a second example, when drop down window 620 is set to ‘Local Favorite’, advertising source 601 preferably produces a list of service providers for the query or selection of a category/subcategory, with service providers designated as a ‘Local Favorite’ 612 (labeled and/or identified as favorite or local favorite) such as American Painters 610 within advertising source 601.

It is still further contemplated that ‘Joe's Painting’ 608 upon becoming an advertiser with advertising source 601 preferably is displayed as an advertising sponsor, wherein ‘Joe's Painting’ is prominently placed in the sponsor section 614. Moreover, upon becoming an advertiser with advertising source 601 ‘Joe's Painting’ 608 preferably is set out as a highlighted service provider, wherein ‘Joe's Painting’ has a highlighted listing 618 in the general service provider listing of screen shot 600 set forth under tabs Recommended 604 and Not Recommended 606.

Moreover, screen shot 600 preferably includes sponsor section 614, wherein sponsor such as ‘Joe's Painting’ 608 preferably is a paid premium placement advertiser within advertising source 601. Advertising source 601 preferably places ‘Joe's Painting’ 608 and the like in a prominent placement such as listing service provider “Joe's Painting” 608 at the top of the general listings of service providers set forth under tabs Recommended 604 and Not Recommended 606 and/or designating or identifying service provider Joe's Painting 608 with a special designation such as labeled and/or identified as favorite or local favorite and/or other identification under sponsor section 614. Moreover, advertising sponsors may publicize a tagline/coupon 616 or other special offer to attract user 302 to service provider Joe's Painting 608 listing, landing page, business profile and/or detailed listing. For example, Joe's Painting is publicizing a coupon to “Save $200 with first job.” and Quick and Able Painters is publicizing a “5 Year Money Back Guarantee!” or other tagline/coupon 616 or designation as would meet the purposes described herein.

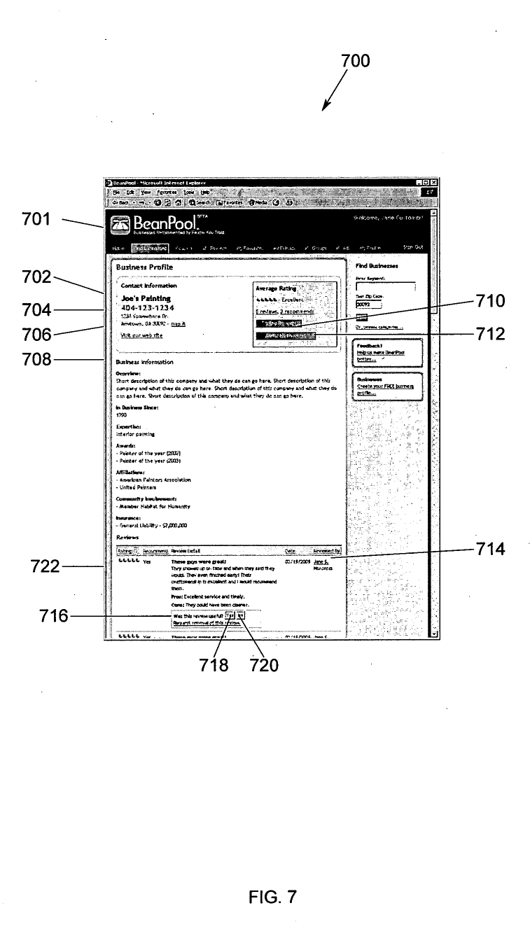

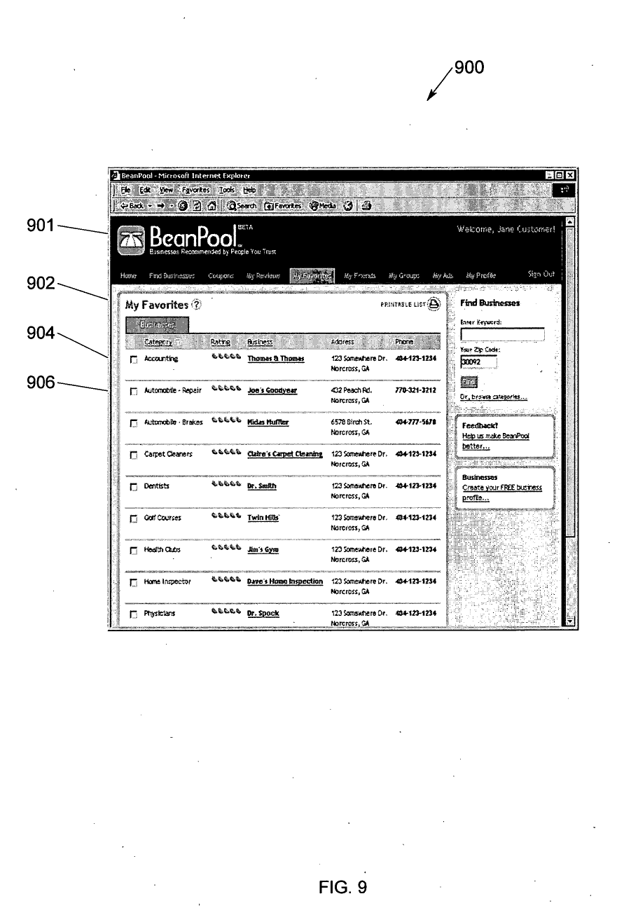

Referring now to FIG. 7, there is illustrated a preferred screen shot 700 of a service provider listing, landing page, business profile and/or detailed listing page within advertising source 701, wherein user 302 can locate among other things the service provider's name 702, business number or advertising source routing number 704, service provider address 706, and service provider's other business information 708 regarding the goods and/or services offered by such service provider, including but not limited to, business overview/description, types of goods and services offered, business description, date started business, how long in business, expertise, awards, affiliations, community involvement, logo, tag line, menu, reviews, ratings, recommendation, pricing, URL, terms and conditions, warranty, license, certification, testimonials (contact information for those providing testimonies), quotes, coupons, special offers, pictures, audio, video and/or other such service provider information as would meet the purpose described herein. Moreover, screen shot 700 preferably includes buttons Write a Review 710, wherein user 302 may select to write a review of service provider 702 such as the review by Jane S. 714. User 302 may select to add this service provider 702 to user's 302 My Favorites List, a list of user's 302 favorite service providers, by preferably clicking the button Add to My Favorites 712 (see FIG. 9).

Furthermore, screen shot 700 preferably includes review abuse process, wherein user 302 preferably designates an individual service provider's review as “useful” by clicking a button labeled “yes” 718 following a question “Was this review useful?” 716 or designate the review as “not useful” by clicking a button labeled “no” 720 following the same question. It is further contemplated that other review abuse systems including, but not limited to, buttons, check boxes, questions and the like and/or other designations or labels other than “useful” including, but not limited to, helpful, beneficial, best, very good, excellent, quality, preferred, highly rated, reviewed or recommended, and the like are contemplated in the present invention.

It is still further contemplated that such review abuse process allows users 302 to identify any self serving reviews, falsely written reviews from a competing service provider or an unjustified review whether positive or negative and the like. Advertising source 701 preferably uses this review abuse process feedback to weight individual service providers reviews as either more or less favorably, as in whether “useful” or “not useful”, resulting in an adjustment to service provider's overall review 722 (number of beans).

It is still further contemplated that such review abuse process may be based on an algorithm to determine whether or not an adjustment to service provider's overall review 722 and the quantity of the adjustment based on users 302 feedback whether a review was “useful” or “not useful.”

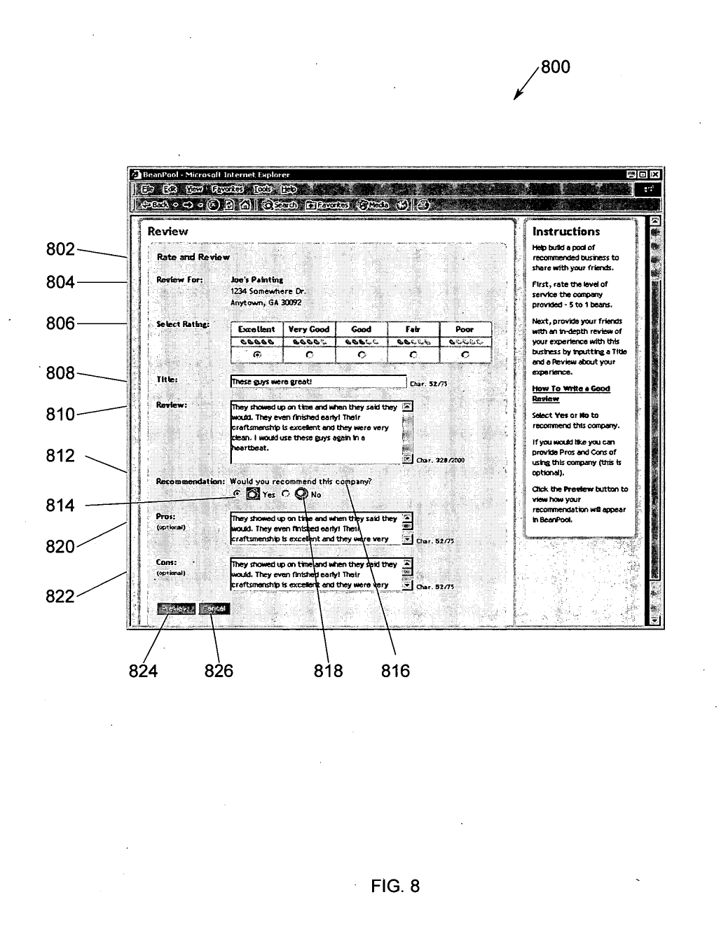

Referring now to FIG. 8, there is illustrated a preferred screen 800 of a service provider's rating, review and/or recommendation webpage, wherein user 302 may rate, review and/or recommend service providers such as Joe's Painting in this example. Upon user 302 clicking the button Write a Review 710 on Joe's Painting screen shot 700 as set forth in FIG. 7, advertising source 701 generates preferred screen shot 800 entitled “Rate and Review” 802. Screen shot 800 preferably comprises Review For 804, wherein service provider's business name and contact information such as address, business phone number, advertising source 701 routing phone number, logo, tag line, URL, category, subcategory and the like are displayed; Select Rating 806, wherein user 302 rates the level of service/goods service provider offered user 302 by preferably selecting or clicking a radial selection button for “Excellent”, “Very Good”, “Good”, “Fair”, or “Poor”, wherein such rating preferably is implemented by user 302 selecting “Excellent” for service providers in the top 10%, “Very Good” for service providers in the top 10-20% range, “Good” for service providers in the middle range, “Fair” for service providers in the bottom 10-20% range, and “Poor” for service providers in the bottom 10%; Title 808, wherein user 302 preferably enters a title for user's 302 review of service provider such as a designation of location, cross street, area, neighborhood, quality, description and the like; Review 810, wherein user 302 preferably enters a text review of service provider and/or service providers goods, services, performance, staff, and/or quality or description of service provider's goods and/or service, and the like; recommendation 812, wherein user 302 preferably clicks a radial button labeled “yes” 814 following a question “Would you recommend this company?” 816 or designates the service provider as “not recommended” by clicking a radial button labeled “no” 818 following the same question (if user clicks “no” advertising source 601 places user 302 review of service provider under tab Not Recommended 606); Pros 820, wherein user 302 preferably enters text of the “pros” of service provider and/or service providers goods, services, performance, staff, and/or quality or description of service provider's goods and/or service, and the like; and Cons 822, wherein user 302 preferably enters text of the. “cons” of service provider and/or service providers goods, services, performance, staff, and/or quality or description of service provider's goods and/or service, and the like. Upon user 302 completing its review of service provider user 302 preferably previews 824 user's 302 review, rating and/or recommendation of service provider and if satisfied user 302 preferably publishes its review of service provider. However, if user 302 is unsatisfied with its review of service provider or user 302 has decided not to rate such service provider user 302 preferably cancels its review by clicking cancel 826.

Referring now to FIG. 9, there is illustrated a preferred screen shot 900 of My Favorites tab within advertising source 901. Upon user 302 clicking the button labeled Add to My Favorites 712 on Joe's Painting screen shot 700 as set forth in FIG. 7, advertising source 701 generates preferred screen shot 900 entitled My Favorites 902 and adds Joe's Painting to user 302 exemplary list of My Favorites. My Favorites 902 preferably is an exemplary list of user's 302 selected favorite service providers. For example, user 302 added Thomas & Thomas 904 under category Accounting and Joe's Goodyear 906 under category Automotive-Repair and the like as user 302 favorite service providers. User 302 may add any number of service providers to My Favorites 902.

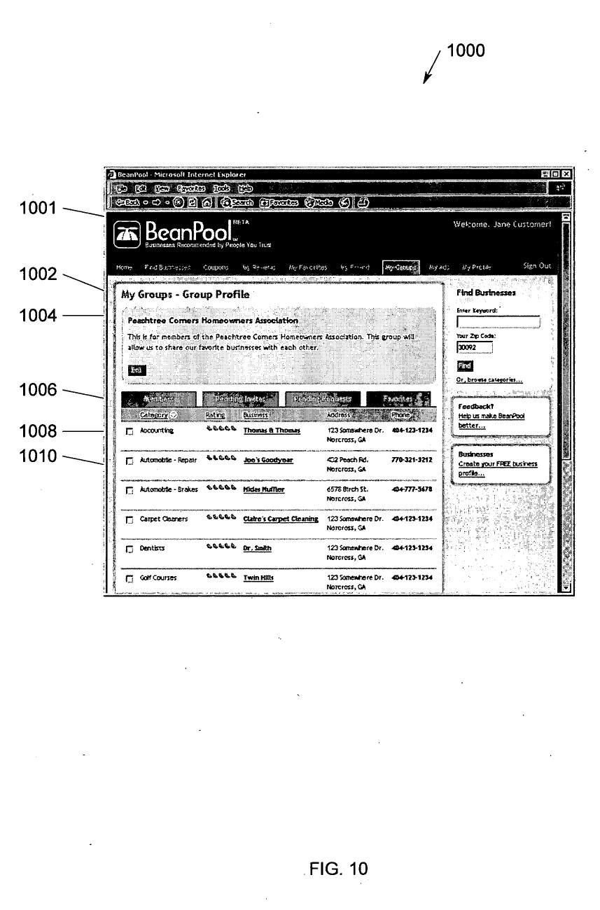

Referring now to FIG. 10, there is illustrated a preferred screen shot 1000 of My Groups tab within advertising source 1001. Upon user 302 clicking the button labeled Add to My Favorites 712 on Joe's Painting screen shot 700 as set forth in FIG. 7, advertising source 701 generates preferred screen shot 900 entitled My Favorites 902 and adds Joe's Painting to user 302 exemplary list of My Favorites as set forth in FIG. 9. Moreover, if two or more users 302 or an average number of users 302 within a group of users 302 who are members of group 1004 entitled “Peachtree Corners Homeowners Association” (or any other group within advertising source 1001) clicks the button labeled Add to My Favorites 712 on Joe's Painting screen shot 700 as set forth in FIG. 7, advertising source 1001 generates preferred screen shot 1000 My Groups—Group Profile 1002 and adds Joe's Painting to group 1004 exemplary list of its users 302 favorite service providers. My Groups—Group Profile 1002 preferably is an exemplary list of users 302, who are members of group 1004. For example, group 1004 includes service providers Thomas & Thomas 1008 under category Accounting and Joe's Goodyear 1010 under category Automotive-Repair and the like as group 1004 favorite service providers, which are highly rated, reviewed, or recommended (favorite) service providers of group 1004.

Alternatively, server 304 preferably determines whether a threshold of users 302 within a group of users have added service provider to user's 302 list of “My Favorites.” (It is contemplated that thresholds such as an individual user 302 or one or more user 302 may be a sufficient determination and/or whether such determination is made based on a pool of users 302 local to group 1004 or users 302 within group 1004 area.) Preferably, user 302 designates service provider as “My Favorite” by selecting a service provider under the tab “Find Businesses” and upon viewing such service provider's information page user 302 may select to add service provider to user's 302 list of “My Favorites”. Moreover, user 302 may create a group of users or join an existing group of users 302 such as group 1004. Server 304 preferably determines whether a threshold of users 302 within a group of users have added service provider to user's 302 list of “My Favorites” and upon meeting such threshold service provider adds service provider to My Groups—Group Profile 1002. (It is contemplated that thresholds such as an individual user 302 or one or more user 302 may be a sufficient determination and/or whether such determination is made based on a pool of users 302 local to group 1004 or users 302 within group 1004 area.)

It is still further contemplated that decision processes (other then clicking a button), questions, formats and/or descriptions for making a selection or decision such as checking a box and clicking enter are contemplated herein.

Group preferably is a collection of users or members with similar interests, needs, associations, purpose and/or other factors, including but not limited to home owners association (those living near one another), swim/tennis community, parent teacher association, sports team, club, religious organization, those working together or for a common goal or any other such association as would meet the purpose described herein.

It is contemplated that other criteria for determining whether a service provider is added to My Favorites or a My Groups is contemplated herein, including but not limited to one, two or more users 302 agreeing to add service provider to users 302 list of favorite service providers.

It is still further contemplated that other ranges, questions, labels, titles, decision processes, review abuse processes, formats and/or descriptions for rating, reviewing and/or recommending service providers, My Favorite, My Group and/or My Favorite Group are contemplated herein.

It is still further contemplated that this apparatus, system and method for identifying, labeling, searching, viewing, sorting and/or filtering favorite or local favorite service provider(s) is used to determine which process herein is a catalyst in effecting a customer or buyer's decision to enter a service provider, become a long-term loyal customer or even facilitate a customer's change of loyalty to a different merchant, store or service provider.

It is still further contemplated that this or a similar apparatus, system and method for identifying, labeling, searching, viewing, sorting and/or filtering favorite or local favorite reviewer of service provider(s), wherein the present invention provides for the searching, sorting, and/or filtering of reviewer's feedback or information based on average reviewer's rating, review and/or recommendation by other users or members.

Although the description given above includes specific examples of currently envisioned embodiments of the computer program, method, system, and/or apparatus, these possibilities should not be understood as limiting the scope of the present invention but rather as providing illustrations of some of the embodiments that are now preferred. Several examples of alternate embodiments are also described and various other alternatives, adaptations, and modifications may be made within the scope of the present invention. Merely listing or numbering the steps or blocks of a method in a certain order does not constitute any limitation on the order of the steps of that method. Many modifications and other embodiments of the invention will come to mind to one skilled in the art to which this invention pertains having the benefit of the teachings presented in the foregoing descriptions and the associated drawings. Although specific terms may be employed herein, they are used in a generic and descriptive sense only and not for purposes of limitation. Accordingly, the claims that follow herein and their legal equivalents, rather than the examples given in the specification, should determine the scope of present.

What is claimed is:

1. A method of labeling a favorite service provider, said method comprising:
viewing a list of service providers;
selecting a service provider based on a user identifying a service provider as a favorite; and
displaying said favorite service provider with a unique label.

2. The method of claim 1, wherein said identification is based on an average user rating of said service provider.

3. The method of claim 1, wherein said identification is based on an average user review of said service provider.

4. The method of claim 1, wherein said identification is based on an average user recommendation of said service provider.

5. The method of claim 1, wherein said identification is based on an average local user feedback of said service provider selected from a group consisting of review, rating, recommendation and combinations thereof.

6. The method of claim 1, wherein said identification is based on an average user feedback and wherein said user designates said service provider as excellent.

7. The method of claim 1, wherein said identification is based on an average user feedback and wherein said user designates said service provider as very good.

8. The method of claim 1, wherein said identification is based on an average local user feedback and wherein said user designation of said service provider is selected from a group consisting of good, very good, excellent and combinations thereof.

9. The method of claim 1, wherein said service provider label is selected from a group consisting of favorite, local favorite, designated area favorite, area, best, very good, excellent, quality, preferred, highly rated, category, subcategory and combinations thereof.

10. The method of claim 1, wherein said service provider label is selected from a group consisting of mark, icon, text, script, font, static graphic, dynamic graphic, audio, video and combinations thereof.

11. The method of claim 1, wherein said viewing of said service providers is based on a user filter selection of said service providers, and wherein said user filter is selected from a group consisting of friends, friends of friends, groups, friends of group, user, area, zip code, zip+4, city, metro area, state, highly rated, reviewed, and/or recommended reviewers, highly rated, reviewed and/or recommended service providers, distance, proximity, coupon, service providers added to user's friends, and/or groups “My Favorites List” and combinations thereof.

12. A method of labeling a favorite service provider, said method comprising the steps of:
determining whether a service provider is a favorite service provider; and
displaying said favorite service provider with a unique label.

13. The method of claim 12, wherein said determination is based on the number of users who confirm a positive review of said service provider is useful.

14. The method of claim 12, wherein said determination is based on the number of users who click a button confirming a positive review of said service provider is useful.

15. The method of claim 12, wherein said determination is based on a number of users who click a first button confirming a positive review of said service provider is useful exceeds a number of users who click a second button confirming a positive review of said service provider is not useful.

16. The method of claim 12, wherein said determination is based on a number of users who add said service provider to said user's list of favorite service providers.

17. The method of claim 12, wherein said determination is based on a number of local users who add said service provider to said user's list of favorite service providers.

18. The method of claim 12, wherein said determination is based on a number of users who click a button to add said service provider to said user's list of favorite service providers.

19. The method of claim 12, wherein said determination is based on a number of users who add said service provider to said user's group list of favorite service providers.

20. The method of claim 12, wherein said determination is based on a number of local users who add said service provider to said user's group list of favorite service providers.

21. The method of claim 12, wherein said determination is based on a number of users who click a button to add said service provider to said user's group list of favorite service providers.

22. The method of claim 12, wherein said service provider label is selected from a group consisting of favorite, local favorite, designated area favorite, area, best, very good, excellent, quality, preferred, highly rated, category, subcategory and combinations thereof.

23. The method of claim 12, wherein said service provider label is selected from a group consisting of mark, icon, text, script, font, static graphic, dynamic graphic, audio, video and combinations thereof.

24. A system for labeling a favorite service provider comprising:
means for determining whether a service provider is a favorite service provider; and
means for displaying said favorite service provider with a unique label.

25. The system of claim 24, wherein said determination is based on a number of users who add said service provider to said user's list of favorite service providers.

26. The system of claim 24, wherein said determination is based on a number of users who add said service provider to said user's group list of favorite service providers.
